(19) United States
(12) Patent Application Publication
(10) Pub. No.: US 2011/0316468 A1
(43) Pub. Date: Dec. 29, 2011

(54) HYBRID MACHINE COMPRISING A SYNCHRONOUS MOTOR AND AN ASYNCHRONOUS MOTOR

(75) Inventors: Ali Makki, Bordeaux (FR); Eric Coupart, Angouleme (FR)

(73) Assignee: MOTEURS LEROY-SOMER, Angouleme (FR)

(21) Appl. No.: 13/122,258

(22) PCT Filed: Oct. 22, 2009
(86) PCT No.: PCT/IB09/54677

§ 371 Date: Jun. 22, 2011

(30) Foreign Application Priority Data
Oct. 22, 2008 (FR) 08 57155

(51) Int. Cl. H02P 1/50; H02K 21/46

(52) U.S. Cl. 318/705; 310/156.78

(57) ABSTRACT

A rotating electrical machine to be connected to a polyphase power grid, having: a polyphase synchronous motor including a rotor with permanent magnets and a polyphase asynchronous motor axially coupled together, and a switching system arranged so as to electrically connect the asynchronous motor to the grid during the machine starting phase in order to bring the synchronous motor to a speed that enables the motor to operate while connected directly to the grid, and to electrically connect the synchronous motor to the grid during a subsequent phase.

The subject of the present invention is a rotating electrical machine comprising a synchronous motor and an asynchronous motor, also called “hybrid machine”.

To handle the starting of a synchronous machine, it is known from WO 89/03936 or US 2003/0071533 to use permanent magnet rotors comprising a starting cage. Such a solution may prove unsuitable when the starting has to be done with a significant load such as the nominal torque of the motor.

Furthermore, because of the presence on the rotor of permanent magnets and a cage, it is preferable for the magnetic flux from the magnets not to have an intensity greater than the stator flux, to the detriment of the specific power density of the machine.

There is a need to further refine the hybrid machines.

The invention aims to address this need. Examples of implementation of the invention relate to a rotating electrical machine, to be linked to a polyphase electricity network, comprising:
a polyphase synchronous motor comprising a rotor with permanent magnets and an axially coupled polyphase asynchronous motor, and,
a switching system, designed to:
   electrically link, during a starting phase of the machine, the asynchronous motor to the electricity network in order to bring the synchronous motor, which is driven by the asynchronous motor, to a speed enabling it to operate by being directly linked to the network, and,
   electrically link the synchronous motor to the electricity network during a subsequent phase.

The expression “axially coupled motors” should be understood to mean two motors having at least one common shaft, for example a monolithic shaft or a shaft formed by two sections with the same axis assembled one after the other.

Such a machine may make it possible, by combining a synchronous motor and an asynchronous motor, to benefit from a significantly greater efficiency than with a single asynchronous motor, the gain being for example between 10 and 15%.

The presence of the rotor with permanent magnets of the synchronous motor may make it possible to obtain a higher power factor for the machine compared to a single asynchronous motor.

Furthermore, the fact of being able to directly link the synchronous motor to the electricity network, that is to say without the intermediary of a frequency variator, may make it possible to obtain an efficiency that is for example at least 5% greater than that of a synchronous motor operating through a frequency variator.

The synchronous motor may comprise 2*N_{Sy} poles and the asynchronous motor may comprise 2*N_{As} poles, with N_{As}=N_{Sy}−1, which may facilitate the synchronization operation, the speed reached on completion of the starting phase then being able to be close to the speed of synchronism of the synchronous motor.

The phases of the synchronous motor are arranged to be in the same order as the phases of the electricity network, in order to avoid having the electromagnetic field of the stator rotate in the reverse direction of the rotation of the rotor of the synchronous motor, the direction initially imposed by the asynchronous motor to which the rotor of the synchronous motor is coupled.

The asynchronous motor may comprise a cage rotor. The rotor cage is for example made of aluminum or copper or another alloy such as brass or bronze.

The notches of the rotor cage may be single or double.

The synchronous motor may comprise a rotor with no cage.

With such a synchronous motor, it is desirable, to facilitate synchronization, for the maximum motor torque delivered by the asynchronous motor, which depends among other things on the electrical resistance of the rotor cage and on the choice of the windings of the stator, to be obtained for a rotation speed of the rotor of the asynchronous motor, and consequently of the rotor of the synchronous motor coupled to the asynchronous motor, that is roughly equal to the speed of synchronism. The speed of synchronism of the synchronous machine is determined by the frequency of the electricity network and by the number of pairs of poles of the synchronous motor.

The expression “roughly equal to the speed of synchronism” should be understood to mean a rotation speed of the rotor of the synchronous motor that is equal to the speed of synchronism of the synchronous motor to within 10%.

The windings of the asynchronous motor are thus advantageously produced so as to generate, when they are linked to the electricity network, a maximum motor torque at a speed roughly equal to the speed of synchronism.

Examples of implementation of the invention introduce greater freedom for the manufacture of the asynchronous machine by avoiding stipulating particular dimensions and materials for the rotor cage as in the known hybrid machines in which the cage and the permanent magnets are supported by the same rotor.

There can be three degrees of freedom, namely the dimensions of the rotor cage of the asynchronous motor, the material or materials used for its production and the choice of the windings of the stator of the asynchronous motor, to vary the maximum motor torque delivered by the asynchronous motor so as to obtain, at a given frequency of the electricity network, a maximum motor torque at speeds of synchronism of synchronous motors with four, six, eight, ten, twelve, fourteen or sixteen poles, or even more. The speed of an asynchronous motor with four poles, when the motor torque delivered by the latter is at maximum, is for example close to the speed of synchronism of a motor with six poles or eight poles depending on the winding and the material of the rotor cage.

As a variant, the rotor of the synchronous motor comprises permanent magnets and a rotor cage. With such a synchronous motor, the maximum motor torque delivered by the asynchronous motor can be obtained for a rotation speed of the rotor of the asynchronous motor, and consequently of the rotor of the synchronous motor coupled to the rotor of the asynchronous motor, that is less than the speed of synchronism of the synchronous motor, for example for a speed less than 80% of the speed of synchronism, for example for a speed between 50% and 80% of the speed of synchronism.

The asynchronous motor may be electrically linked to the network only during the starting phase or remain linked to the network after the starting phase.

The asynchronous motor may have no permanent magnets.

According to a first embodiment, the machine comprises a single casing inside which the synchronous motor and the asynchronous motor are housed.

According to another embodiment, only the synchronous motor is housed inside a first casing, the asynchronous motor being arranged outside of this first casing, in a second casing. The latter is, for example, screwed to a flange situated substantially at one of the longitudinal ends of the first casing.

The asynchronous motor may be relatively compact, the ratio between the length of the asynchronous motor, measured between the end turns of the windings of the stator of the asynchronous motor, and that of the synchronous motor, measured between the end turns of the windings of the stator of the synchronous motor, being for example between 20% and 35%.

The shaft of the synchronous and asynchronous motors is for example mounted on the single casing of the machine or, when the machine comprises two casings, on the first casing of the machine. The shaft may be supported by bearings arranged at the two longitudinal ends of the single casing of the machine or, if appropriate, of the first casing of the machine.

The switching system may comprise a control circuit and a synchronization circuit.

The control circuit may comprise electromechanical switches or semiconductor power switches.

The synchronization circuit comprises for example a voltage observer arranged to compare the voltage of the power supply network and the electromotive force induced in the windings of the stator of the synchronous motor, when the latter is driven by the asynchronous motor.

The synchronization circuit is for example arranged to compare the order of the phases of the electricity network and the electromotive force induced in the windings of the stator of the synchronous motor, when the latter is driven by the asynchronous motor.

The synchronization circuit may or may not include a speed observer arranged to detect the rotation frequency of the synchronous motor. The synchronization circuit for example has no Hall effect sensor, coder or tachometer resolver.

The synchronization circuit comprises for example at least one programmable electronic component, a microcontroller for example.

The control circuit is for example arranged to selectively power the synchronous motor or the asynchronous motor according to information received from the synchronization circuit.

Examples of implementation of the invention mentioned above may make it possible to produce a synchronization that is commonly qualified as flexible, this synchronization being performed when the frequency of the voltage induced in the windings of the synchronous motor is roughly equal to the power supply frequency of the network, with potential differences between the phases of the network and between the phases of the synchronous motor being cancelled out at the same time.

Other example of implementation of the invention relate to a method for starting a rotating electrical machine to be linked to a polyphase electricity network, comprising an asynchronous motor axially coupled to a synchronous motor and comprising a switching system, this method comprising the steps consisting in:
electrically linking to the network, during a starting phase of the machine, only the asynchronous motor in order to bring the synchronous motor to a speed enabling it to operate by being directly linked to the network, and
electrically linking the synchronous motor to the network during a subsequent phase.

The speed enabling the synchronous motor to operate by being directly linked to the network is for example the speed of synchronism of the synchronous motor.

As a variant, the speed enabling the synchronous motor to operate by being directly linked to the network is less than the speed of synchronism of the synchronous motor, it being for example less than 80% of the speed of synchronism, it being notably between 50% and 80% of the speed of synchronism.

During the starting phase, the asynchronous motor may be subject to a load torque.

The rotating electrical machine is for example a fan and the load torque, for example quadratic, is supplied by a cooling system.

As a variant, the load corresponds to a constant or linear resisting torque, for example a load torque that is linear as a function of the speed or constant.

During the subsequent phase, only the synchronous motor may be electrically linked to the network.

According to examples of implementation of the invention, the synchronization operation may be performed at least partly by the load-resisting torque.

The method may comprise the step consisting in comparing, during the starting phase, the electromotive force induced in the windings of the synchronous motor and the voltage of the electricity network before electrically linking the synchronous motor to the network.

The invention may be better understood on reading the following detailed description of nonlimiting examples and studying the appended drawing in which;

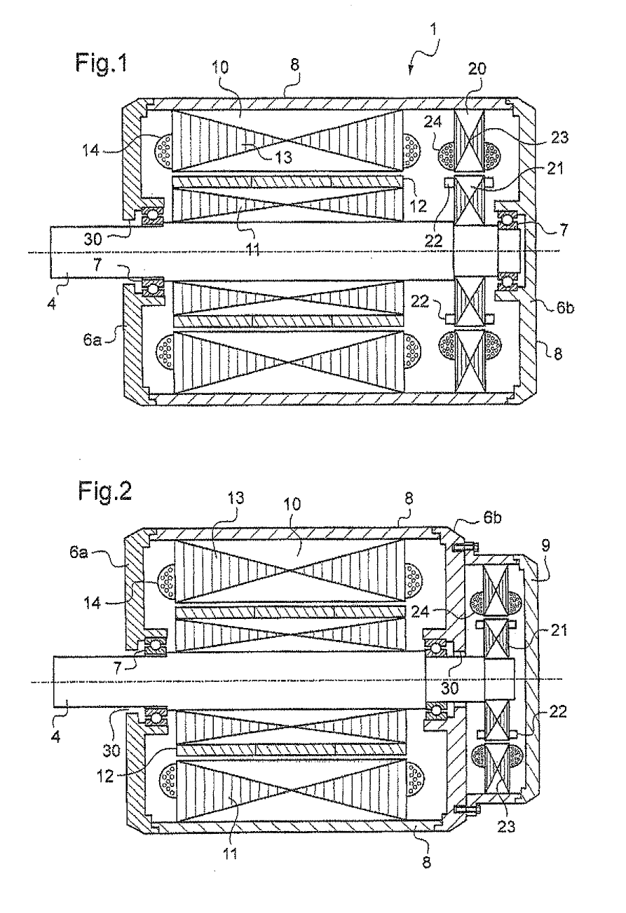

FIG. 1 schematically and partially represents a first example, in axial cross-section, of an electrical machine according to the invention,

FIG. 2 is a view similar to FIG. 1 of a second example of an electrical machine according to the invention,

FIG. 3 is a schematic representation of a machine according to the invention,

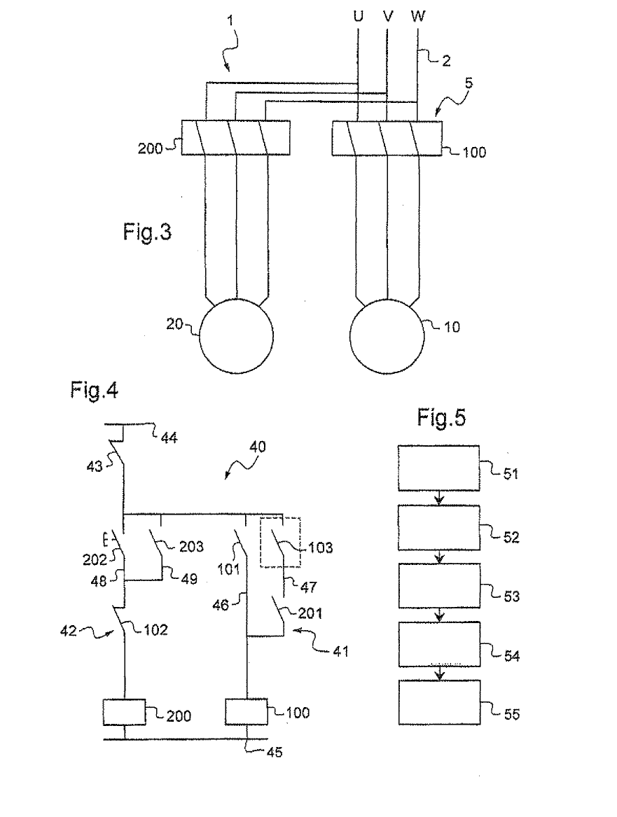

FIG. 4 schematically represents an example of a control circuit according to the invention,

FIG. 5 represents an operating sequence of the circuit represented in FIG. 4,

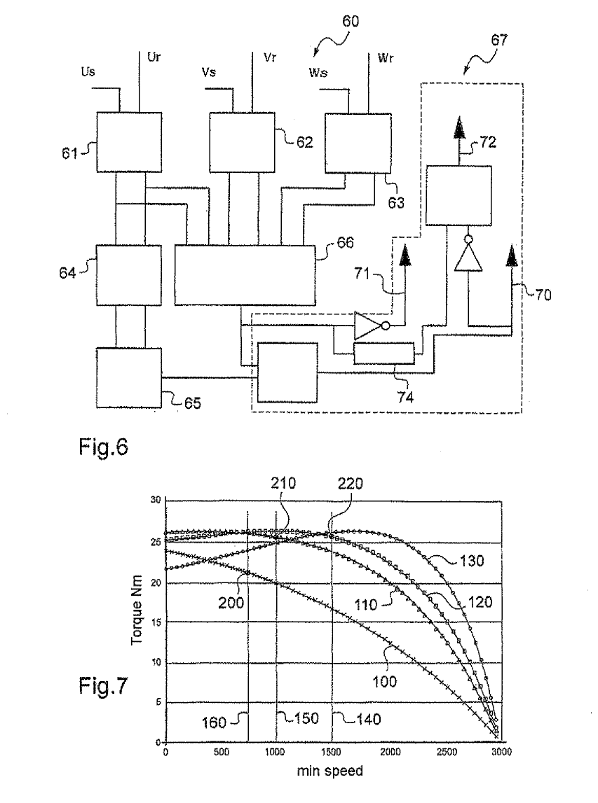

FIG. 6 is a representation in logical form of an example of a synchronization circuit according to the invention,

FIG. 7 is a diagram illustrating the possibility, by virtue of the invention, of obtaining different speeds of synchronism for a given frequency of the electricity network, and

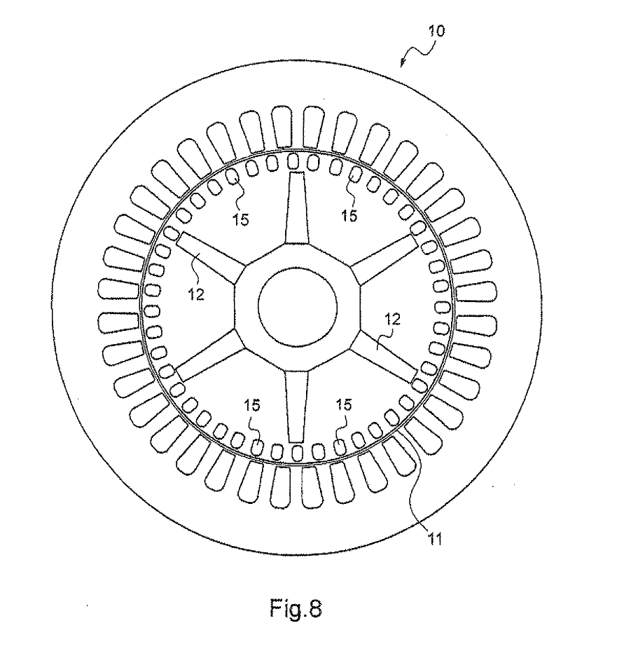

FIG. 8 is a cross-sectional view of another example of a synchronous motor according to the invention.

FIGS. 1 and 2 show two exemplary hybrid rotating electrical machines 1 according to the invention.

The machine 1 is a polyphase rotating electrical machine, for example three-phase.

This machine 1 has a nominal power ranging for example from 250 W to 4 kW.

The electrical machine 1 comprises a synchronous motor 10 and an asynchronous motor 20, axially coupled along a rotation axis X of the machine.

As can be seen in FIGS. 1 and 2, the asynchronous motor 20 is relatively compact compared to the synchronous motor 10.

The asynchronous motor 20 is, for example, a four-pole machine and the synchronous motor 10 is, for example, a six-pole machine.

The synchronous motor 10 comprises a rotor 11 comprising permanent magnets 12, which may, for example, be magnets arranged on the surface or embedded. The rotor 11 is flux concentration rotor for example.

In the example represented in FIGS. 1 and 2, the rotor 11 has no rotor cage but there is no departure from the present invention when the rotor 11 of the synchronous motor 10 comprises a rotor cage.

In the example of FIG. 8, the synchronous motor 10 comprises a rotor comprising permanent magnets 12 and a rotor cage 15 of which only the bars are represented.

In the examples considered, the synchronous motor is a radial machine with internal rotor, the rotor 11 being surrounded by a stator 13 comprising windings 14.

The asynchronous motor 20 is also a radial machine with internal rotor 21 in the examples of FIGS. 1 and 2.

Obviously, the invention is not limited to such examples and the synchronous motor and the asynchronous motor may be radial machines with external rotor for example. The synchronous motor 10 may, in a variant not represented, be a discoid machine.

The asynchronous motor 20 comprises, in the examples of FIGS. 1 and 2, a cage rotor 21, the latter being formed by a plurality of electrically conductive bars 22 linked at their ends by two electrically conductive rings which are not represented.

The rotor 21 of the asynchronous motor 20, in the example described, has no permanent magnet.

As can be seen in FIGS. 1 and 2, the two motors have a common shaft 4, which may be monolithic. This shaft 4 is, in the example of FIG. 1, mounted in the casing 8 of the machine on two bearings 7 borne by front and rear flanges 6a and 6b defining the two longitudinal ends of the casing 8.

In the example described, the front flange 6a has a central opening 30 through which the shaft 4 extends outside of the casing 8.

As can be seen in FIG. 1, the shaft 4 extends according to this example outside the casing 8 only at one end of said casing.

Still in this example, the synchronous 10 and asynchronous 20 motors are both housed inside the casing 8 of the machine.

In the variant represented in FIG. 2, the machine 1 comprises a first casing 8 inside which the synchronous motor 10 is housed and a second casing 9 inside which the asynchronous motor 20 is housed.

As can be seen in FIG. 2, the second casing 9 is, for example, fixed by screws to the rear flange 6b of the first casing 8.

In the example of FIG. 2, the shaft 4 passes through each of the flanges 6a and 6b with the help of respective central openings 30.

The shaft 4 is supported by bearings 7 respectively borne by the front 6a and rear 6b flanges.

The electrical machine 1, schematically represented in FIG. 3, also comprises a switching system 5 intended to link the stators 13 and 23 of the synchronous and asynchronous motors to the electricity network 2.

The switching system 5 comprises switches which are, in the example of FIG. 3, electromechanical relays 100 and 200, respectively associated with the synchronous motor 10 and with the asynchronous motor 20. Each relay 100 and 200 comprises, in the example described, windings and a series of contacts.

Obviously, the invention is not limited to the use of electromechanical relays to implement the switches 100 and 200.

As a variant, these switches can be contactors, transistors, thyristors, triacs or solid-state relays.

The switching system 5 comprises, in the example described, a control circuit 40 and a synchronization circuit 60, respectively schematically represented in FIGS. 4 and 6.

As can be seen in FIG. 4, the control circuit 40 may comprise two circuit portions 41 and 42, each circuit portion providing the electrical power supply for the windings of a relay 100 or 200 in order to allow this relay to switch from an open state to a closed state for example.

In the example described, the two circuit portions 41 and 42 are mounted in parallel between a switch 43 and ground 45. The switch 43 is mounted in series with a voltage source 44, delivering, for example, a voltage of between 12V and 400V.

The circuit portion 41 comprises the relay 100, linked in series to two branches 46 and 47 mounted in parallel, the branch 46 comprising a switch 101 and the branch 47 comprising two switches 201 and 103, mounted in series.

The circuit portion 42 comprises the relay 200, linked in series to a switch 102, the latter being linked in series to two branches 48 and 49 mounted in parallel, the branch 48 comprising a switch 202 and the branch 49 comprising a switch 203.

The switches 43, 101, 102, 103, 201 and 203 may be electromechanical switches or semiconductor switches. The switches 43, 101, 102, 103, 201 and 203 are, for example, of the same type as the switches 100 and 200.

The switch 202 is, for example, a controllable switch. In the example of FIG. 4, the switch 202 can be controlled to close, for example by virtue of a push button.

The switches 101, 102 and 103, respectively 201, 202 and 203, are arranged to change state according to the state of the switch 100, respectively 100.

When the switch 200 changes from the open state to the closed state, the switches 201 and 203 switch, for example, from the open state to the closed state.

When the switch 100 switches from the open state to the closed state, the switch 102 switches, for example, from the closed state to the open state whereas the switch 101 switches from the open state to the closed state.

There now follows a description with reference to FIG. 5 of an operating sequence of the control circuit represented in FIG. 4.

Before the machine is started, the switches 101, 103, 201, 202 and 203 are open and the switch 102 is closed.

In a first step 51, the switch 202 is ordered to close, notably by actuation of a push button. Following this step 51, the windings of the relay 200 are electrically linked to the electricity source 44 through the closed switches 102 and 202, which causes power to be supplied to the asynchronous motor 20 by the electricity network 2 and, consequently, the asynchronous motor 20 to start.

In the step 52, the switches 201 and 203 switch to the closed position, which makes it possible, among other things, to ensure a self-powering of the windings of the relay 200, independently of the subsequent trend of the switch 202.

In the step 53, the control circuit 40 receives, as will be seen hereinafter, an order to power the synchronous motor 10 originating from the synchronization circuit 60. The reception of this order causes the switch 103 to close. On completion of this step, the windings of the relay 100 are electrically linked through the closed switches 201 and 103 to the electricity source 44.

In the step 54, the switch 101 switches to the closed position whereas the switch 102 switches to the open position, which causes the electrical power supply to the windings of the relay 200 from the electricity source 44, and consequently the supply to the asynchronous motor 20 by the electricity network, to be interrupted.

In the step 55, the switches 201 and 203 switch to the open position because of the change of state of the switch 200, the power supply of the windings of the relay 100 then being ensured through the closed switch 101. Thus, on completion of this sequence, only the windings of the relay 100 are electrically powered by the source 44 and, consequently, only the synchronous motor 10 is electrically linked to the network 2.

There now follows a description in the form of a logical representation of an exemplary synchronization circuit 60 according to the invention.

This synchronization circuit is, for example, produced using a programmable electronic component, for example a microcontroller.

The synchronization circuit 60 is, in the example described, arranged to provide a voltage observation function by comparing the voltage of the power supply network 2 and the electromotive force induced in the windings 14 of the stator 13 of the synchronous motor 10, when the latter is driven by the asynchronous motor 20 to which it is coupled.

The voltage observation function is handled using blocks 61, 62 and 63, each of these blocks being dedicated to the observation of a phase of the voltage.

The block 61 receives as input the voltage Us at the terminals of the phase U of the stator 13 of the synchronous motor 10 and the voltage Ur at the terminals of the phase U of the electricity network 2.

Similarly, the block 62 receives the inputs Vs and Vr, relating to the phase V and the block 63 receives the inputs Ws and Wr relating to the phase W.

These blocks 61, 62 and 63 present at the output a signal representative of the potential difference between the phases of the synchronous motor and those of the electricity network.

The output signal from the blocks 61, 62 and 63 is, for example:
a radio signal comprising a carrier and an amplitude, in the case of a phase difference between the induced electromotive force at the terminals of the stator of the synchronous motor and the network voltage or when these two voltages exhibit different frequencies, or,
a sinusoidal wave of amplitude corresponding to the difference between the amplitude of the electromotive force induced in the windings of the stator of the synchronous motor and the amplitude of the voltage of the power supply network, when the two compared voltages exhibit the same frequencies.

If appropriate, a demodulation operation is performed by the block 64 in order to separate the amplitude from the carrier.

The synchronization circuit 60 is also arranged to perform an operation to detect the minimum potential difference between the electromotive force induced in the windings 14 of the stator 13 of the synchronous motor 10 and the electricity network 2 via the block 65. As can be seen in FIG. 6, the block 65 receives as input the output signal from the block 64.

The synchronization circuit is also arranged to compare, via the block 66, the order of the phases of the electromotive force induced in the windings 14 of the stator 13 of the synchronous motor 10, when the latter is driven by the asynchronous motor 20 to which it is coupled, and the order of the phases of the voltage of the electricity network 2.

The signals at the output of the blocks 65 and 66 are transmitted to a logic circuit 67 schematically represented in FIG. 6.

The logic circuit 67 has three outputs 70, 71 and 72.

The output 70 corresponds to the sending to the control circuit 40 of an order to power the synchronous motor 10 according to the step 53 described previously.

The outputs 71 and 72 correspond to the sending to the control circuit 40 of an order to stop the system causing the power supply to the asynchronous motor 20 to be stopped by acting on a relay which is not represented.

When the detection of the minimum voltage has been performed by the block 65 and on completion of the comparison of the order of the phases by the block 66, and when the order of the phases between the electromotive force induced in the windings 14 of the stator 13 of the synchronous motor 10 and the electricity network 2 has been detected as being the same, the output 70 of the logic circuit is activated to send the order to power the synchronous motor 10 to the control circuit 40 according to step 53.

When the order of the phases between the electromotive force induced in the windings 14 of the synchronous motor 10 and the electricity network 2 has not been detected as being the same by the bloc 66, the output 71 of the logic circuit 67 is activated to give the order to stop the system to the control circuit 40.

If the phases have been detected as being the same by the block 66 but no minimum has been detected by the block 65, the logic circuit 67 activates a time delay 74. After a predefined time interval, if no minimum has been detected by the block 65, the output 72 of the logic circuit 67 is activated to give the order to stop the system to the control circuit 40.

FIG. 7 represents, in diagram form, examples of speeds of synchronism that can be obtained by virtue of an electrical machine 1 according to exemplary embodiments of the invention in which the synchronous motor has no rotor cage.

The frequency of the electricity network 2 is, for example, 50 Hz. The invention is obviously not limited to such an electrical frequency value, the latter being able, for example, to be 60 Hz. The asynchronous motor delivers, for example, a maximum motor torque of between 15 and 40 Nm at a speed of 1000 min⁻¹, in particular between 20 and 25 Nm. The curves 100, 110, 120 and 130 give the motor torque of the asynchronous motor 20 as a function of the rotation speed of the rotor 21, for different values of the electrical resistance of the rotor cage 22. The straight lines 140, 150 and 160 respectively represent the speeds of synchronism of synchronous machines 10 with four, six and eight poles.

As can be seen, by varying the electrical resistance values of the rotor cage 22, load points 200, 210 and 220 are obtained that are suited to different synchronism speed values.

In another example which is not represented, the windings 24 of the stator 23 of the asynchronous motor 20 can be chosen so that the maximum motor torque of the asynchronous motor 20 can be adapted to different synchronism speed values depending on the number of poles of the synchronous machine 10.

The invention applies more particularly to the fields of aeraulics, notably to produce electric fans, and hydraulics, notably to produce hydraulic pumps.

In the claims, the expression “comprising a” should be understood to mean “comprising at least one” unless otherwise specified.

1-20. (canceled)

21. A rotating electrical machine configured to be linked to a polyphase electricity network, comprising:
a polyphase synchronous motor comprising a rotor with permanent magnets and an axially coupled polyphase asynchronous motor, and,
a switching system, configured to:
electrically link, during a starting phase of the machine, the asynchronous motor to the network in order to bring the synchronous motor to a speed enabling said synchronous motor to operate by being directly linked to the network and,
electrically link the synchronous motor to the network during a subsequent phase.

22. The machine as claimed in claim 21, the synchronous motor comprising 2*N_{Sy} poles and the asynchronous motor comprising 2*N_{As} poles, with N_{As}=N_{Sy}−1.

23. The machine as claimed in claim 21, the asynchronous motor comprising a cage rotor.

24. The machine as claimed in claim 21, the synchronous motor comprising a rotor with no rotor cage.

25. The machine as claimed in claim 21, the asynchronous motor generating a maximum motor torque at a rotation speed roughly equal to the speed of synchronism of the synchronous motor.

26. The machine as claimed in claim 21, the synchronous motor comprising a cage rotor.

27. The machine as claimed in claim 21, the asynchronous motor generating a maximum motor torque at a rotation speed below the speed of synchronism of the synchronous motor.

28. The machine as claimed in claim 21, comprising a casing inside which the synchronous motor and the asynchronous motor are housed.

29. The machine as claimed in claim 21, comprising a first casing inside which the synchronous motor is housed, and a second casing inside which the asynchronous motor is housed.

30. The machine as claimed in claim 21, the ratio between the length of the asynchronous motor and that of the synchronous motor being between 20% and 35%.

31. The machine as claimed in claim 21, the switching system comprising a control circuit and a synchronization circuit.

32. The machine as claimed in claim 31, the synchronization circuit comprising a voltage observer configured to compare the voltage of the power supply network and the electromotive force induced in the windings of the synchronous motor, when the latter is driven by the asynchronous motor.

33. The machine as claimed in claim 31, the synchronization circuit being configured to compare the order of the phases of the voltage of the electricity network and the electromotive force induced in the windings of the synchronous motor, when the latter is driven by the asynchronous motor.

34. The machine as claimed in claim 31, the synchronization circuit having no speed observer.

35. The machine as claimed in claim 21, the control circuit being configured to selectively power the synchronous motor or the asynchronous motor according to information received from the synchronization circuit.

36. A method for starting a rotating electrical machine to be linked to a polyphase electricity network, and comprising an asynchronous motor axially coupled to a synchronous motor and a switching system, the method comprising:
electrically linking to the network, during a starting phase of the machine, only the asynchronous motor in order to bring the synchronous motor to a speed enabling said synchronous motor to operate by being directly linked to the network, and
electrically linking the synchronous motor to the network during a subsequent phase.

37. The method as claimed in claim 36, in which the speed enabling the synchronous motor to operate by being directly linked to the network is the speed of synchronism of the synchronous motor.

38. The method as claimed in claim 36, in which the speed enabling the synchronous motor to operate by being directly linked to the network is less than the speed of synchronism of the synchronous motor.

39. The method as claimed in claim 36, in which only the synchronous motor is electrically linked to the network during the subsequent phase.

40. The method as claimed in claim 36, comprising: comparing, during the starting phase, the electromotive force induced in the synchronous motor and the voltage of the electricity network before electrically linking the synchronous motor to the network.
